(19) United States
(12) Patent Application Publication
(10) Pub. No.: US 2022/0398277 A1
(43) Pub. Date: Dec. 15, 2022

(54) METHOD FOR RECOMMENDING WORKS AND SERVER

(71) Applicant: BEIJING DAJIA INTERNET INFORMATION TECHNOLOGY CO., LTD., Beijing (CN)

(72) Inventors: Haocheng WEN, Beijing (CN); Gang ZENG, Beijing (CN); Yanbin ZHAO, Beijing (CN)

(21) Appl. No.: 17/891,465

(22) Filed: Aug. 19, 2022

Related U.S. Application Data
(63) Continuation of application No. PCT/CN2021/076195, filed on Feb. 9, 2021.

(30) Foreign Application Priority Data
Feb. 20, 2020 (CN) 202010104322.6

(51) Int. Cl. G06F 16/435

(52) U.S. Cl. CPC G06F 16/437

(57) ABSTRACT

A method for recommending works is provided. The method includes: receiving, from a login account of an application, a recommendation request; acquiring, in response to the recommendation request, a first candidate work set of each type of a plurality of types, wherein the first candidate work set includes multimedia works posted by an associated account of the login account in the application; screening the first candidate work sets, and aggregating screening results into a second candidate work set, wherein the second candidate work set includes multimedia works of the plurality of types; and ranking multimedia works of the plurality of types in the second candidate work set, and recommending the multimedia works to the login account based on a ranking result.

### CROSS-REFERENCE TO RELATED APPLICATION

This application is a continuation of PCT Application No. PCT/CN2021.1076195, filed on Feb. 9, 2021, which claims priority to Chinese Patent Application No. CN202010104322.6, filed on Feb. 20, 2020, the disclosures of which are herein incorporated by reference in their entirety.

### TECHNICAL FIELD

The present disclosure relates to the field of information technologies, and in particular, relates to a method for recommending works and a server.

### BACKGROUND

With the development of information technologies, many types of feeds emerged. A feed combines several information sources that a user actively subscribes to form a feed aggregator, so as to help the user continuously acquire latest feed content.

Different types of feeds mixing in a same exposure scenario and competing traffic with each other is a common requirement for product recommendation or search. Currently, a way to rank the different types of feeds includes first separately ranking the different types of feeds and then mixing and arranging the different types of feeds based on a specific breakup rule.

### SUMMARY

The present disclosure provides a method for recommending works and a server. Technical solutions of the present disclosure include the following.

According to one aspect of embodiments of the present disclosure, a method for recommending works is provided. The method includes: receiving, from a login account of an application, a recommendation request for display of a multimedia work, wherein the multimedia work is posted by an associated account of the login account in the application acquiring, in response to the recommendation request, a first candidate work set of each type of a plurality of types, wherein the first candidate work set includes multimedia works posted by the associated account; screening the first candidate work sets, and aggregating screening results into a second candidate work set, wherein the second candidate work set includes multimedia works of the plurality of types; and ranking multimedia works of the plurality of types in the second candidate work set, and recommending the multimedia works to the login account based on a ranking result.

In an embodiment, said ranking the multimedia works of the plurality of types in the second candidate work set includes: ranking the multimedia works in the second candidate work set based on an engagement degree and recommendation guidance information set by an application platform, wherein the engagement degree is indicative of a positive feedback operation or a negative feedback operation performed by an account on a history multimedia work, and the recommendation guidance information includes at least one of recommendation information for indicating a recommendation level of the application platform for the history multimedia work and guidance information for prompting the account to perform a positive feedback operation on the history multimedia work.

In an embodiment, said ranking the multimedia works in the second candidate work set based on the engagement degree and the recommendation guidance information set by the application platform includes: acquiring a ranking sequence of the multimedia works of the plurality of types by inputting the multimedia works of the plurality of types in the second candidate work set into a hybrid ranking model, wherein the hybrid ranking model is acquired by training based on the engagement degree and the recommendation guidance information set by the application platform.

According to another aspect of the embodiments of the present disclosure, a method for training a hybrid ranking model for recommending works is provided. The method includes: acquiring a plurality of types of sample sets, wherein the sample set includes positive samples and negative samples, the positive sample being a displayed history multimedia work that is tapped by an account, and the negative sample being a displayed history multimedia work that is not tapped by the account; determining a ranking score of each of the positive samples in the sample set based on an engagement degree and recommendation guidance information set by an application platform, wherein the engagement degree is indicative of a positive feedback operation or a negative feedback operation performed by the account on a history multimedia work, and the recommendation guidance information includes at least one of recommendation information for indicating a recommendation level of the application platform for the history multimedia work and guidance information for prompting the account to perform a positive feedback operation on the history multimedia work; and training the hybrid ranking model based on the ranking score of each of the positive samples in the sample set and the sample set.

In an embodiment, said training the hybrid ranking model based on the ranking score of each of the positive samples in the sample set and the sample set includes: generating, for each of the positive samples, target positive samples at a quantity equal to the ranking score of each of the positive samples; training, based on the sample set and the target positive sample, a positive-sample probability determining model for determining a probability of the target positive sample: and training the hybrid ranking model based on the probability of the target positive sample and a probability that each sample in the sample set is a positive sample.

In an embodiment, said determining the ranking score of each of the positive samples in the sample set based on the engagement degree and the recommendation guidance information set by the application platform includes: acquiring a positive feedback operation performed by each account on each of the positive samples and a weight thereof; acquiring a negative feedback operation performed by each account on each of the positive samples and a weight thereof; determining, based on the acquired positive feedback operation and weight thereof as well as the negative feedback operation and the weight thereof, the engagement degree of each account in each of the positive samples; determining, based on the recommendation guidance information set by the application platform for each of the positive samples, a weight of the engagement degree of each account in each of the positive samples; and determining, based on the engagement degree of each account in each of the positive samples and the weight thereof, the ranking score of each of the positive samples in the sample set.

In an embodiment, said determining, based on the acquired positive feedback operation and weight thereof as well as the negative feedback operation and the weight thereof, the engagement degree of each account in each of the positive samples includes: for each feedback operation, adjusting, in response to a current feedback operation being a low-frequency feedback operation, a weight of the current feedback operation to a ratio of an occurrence frequency of a target high-frequency feedback operation to an occurrence frequency of the low-frequency feedback operation, wherein the occurrence frequency of the target high-frequency feedback operation is an average occurrence frequency of all high-frequency feedback operations in all currently acquired feedback operations; and determining, based on each feedback operation and the adjusted weight thereof, the engagement degree of each account in each of the positive samples.

According to yet another aspect of the embodiments of the present disclosure, an apparatus for recommending works is provided. The apparatus includes: a receiving module, configured to receive, from a login account of an application, a recommendation request for display of a multimedia work, wherein the multimedia work is posted by an associated account of the login account in the application; an acquiring module, configured to acquire, in response to the recommendation request, a first candidate work set of each type of a plurality of types, wherein the first candidate work set includes multimedia works posted by the associated account; a screening and aggregating module, configured to screen the first candidate work sets, and aggregate screening results into a second candidate work set, wherein the second candidate work set includes multimedia works of the plurality of types; and a ranking module, configured to rank multimedia works of the plurality of types in the second candidate work set, and recommend the multimedia works to the login account based on a ranking result.

In an embodiment, the ranking module is configured to rank the multimedia works in the second candidate work set based on an engagement degree and recommendation guidance information set by an application platform, wherein the engagement degree is indicative of a positive feedback operation or a negative feedback operation performed by an account on a history multimedia work, and the recommendation guidance information includes at least one of recommendation information for indicating a recommendation level of the application platform for the history multimedia work and guidance information for prompting the account to perform a positive feedback operation on the history multimedia work.

In an embodiment, the ranking module is configured to acquire a ranking sequence of the multimedia works of the plurality of types by inputting the multimedia works of the plurality of types in the second candidate work set into a hybrid ranking model, wherein the hybrid ranking model is acquired by training based on the engagement degree and the recommendation guidance information set by the application platform.

In an embodiment, the ranking module includes: a training sub-module, configured to train a hybrid ranking model based on the engagement degree and the recommendation guidance information set by the application platform, wherein the hybrid ranking model is used to determine, based on the engagement degree and the recommendation guidance information, a ranking sequence of multimedia works; and a ranking sub-module, configured to acquire the ranking sequence of the multimedia works of the plurality of types in the second candidate work set by inputting the multimedia works of the plurality of types in the second candidate work set into the hybrid ranking model trained by the training sub-module.

In an embodiment, the training sub-module includes: an acquiring unit, configured to acquire a plurality of types of sample sets, wherein the sample set includes positive samples and negative samples, the positive sample being a displayed history multimedia work that is tapped by an account, and the negative sample being a displayed history multimedia work that is not tapped by the account; a determining unit, configured to determine a ranking score of each of the positive samples in the sample set based on an engagement degree and recommendation guidance information set by an application platform, wherein the engagement degree is indicative of a positive feedback operation or a negative feedback operation performed by the account on a history multimedia work, and the recommendation guidance information includes at least one of recommendation information for indicating a recommendation level of the application platform for the history multimedia work and guidance information for prompting the account to perform a positive feedback operation on the history multimedia work; and a training unit, configured to train the hybrid ranking model based on the ranking score of each of the positive samples in the sample set and the sample set.

In an embodiment, the training unit is configured to: generate, for each of the positive samples, target positive samples at a quantity equal to the ranking score of each of the positive samples; train, based on the sample set and the target positive sample, a positive-sample probability determining model for determining a probability of the target positive sample; and train the hybrid ranking model based on the probability of the target positive sample and a probability that each sample in the sample set is a positive sample.

In an embodiment, the determining unit is configured to: acquire a positive feedback operation performed by each account on each of the positive samples and a weight thereof; acquire a negative feedback operation performed by each account on each of the positive samples and a weight thereof; determine, based on the acquired positive feedback operation and weight thereof as well as the negative feedback operation and the weight thereof, the engagement degree of each account in each of the positive samples; determine, based on the recommendation guidance information set by the application platform for each of the positive samples, a weight of the engagement degree of each account in each of the positive samples; and determine, based on the engagement degree of each account in each of the positive samples and the weight thereof, the ranking score of each of the positive samples in the sample set.

In an embodiment, the determining unit is configured to: for each feedback operation, adjust, in response to a current feedback operation being a low-frequency feedback operation, a weight of the current feedback operation to a ratio of an occurrence frequency of a target high-frequency feedback operation to an occurrence frequency of the low-frequency feedback operation, wherein the occurrence frequency of the target high-frequency feedback operation is an average occurrence frequency of all high-frequency feedback operations in all currently acquired feedback operations; and determine, based on each feedback operation and the adjusted weight thereof, the engagement degree of each account in each of the positive samples.

According to still another aspect of the embodiments of the present disclosure, an apparatus for training a hybrid ranking model for recommending works is provided. The apparatus includes: an acquiring unit, configured to acquire a plurality of types of sample sets, wherein the sample set includes positive samples and negative samples, the positive sample being a displayed history multimedia work that is tapped by an account, and the negative sample being a displayed history multimedia work that is not tapped by the account; a determining unit, configured to determine a ranking score of each of the positive samples in the sample set based on an engagement degree and recommendation guidance information set by an application platform, wherein the engagement degree is indicative of a positive feedback operation or a negative feedback operation performed by an account on a history multimedia work, and the recommendation guidance information includes at least one of recommendation information for indicating a recommendation level of the application platform for the history multimedia work and guidance information for prompting the account to perform a positive feedback operation on the history multimedia work; and a training unit, configured to train the hybrid ranking model based on the ranking score of each of the positive samples in the sample set and the sample set.

In an embodiment, the training unit is configured to: generate, for each of the positive samples, target positive samples at a quantity equal to the ranking score of each of the positive samples; train, based on the sample set and the target positive sample, a positive-sample probability determining model for determining a probability of the target positive sample; and train the hybrid ranking model based on the probability of the target positive sample and a probability that each sample in the sample set is a positive sample.

In an embodiment, the determining unit is configured to: acquire a positive feedback operation performed by each account on each of the positive samples and a weight thereof; acquire a negative feedback operation performed by each account on each of the positive samples and a weight thereof; determine, based on the acquired positive feedback operation and weight thereof as well as the negative feedback operation and the weight thereof, an engagement degree of each account in each of the positive samples; determine, based on the recommendation guidance information set by the application platform for each of the positive samples, a weight of the engagement degree of each account in each of the positive samples; and determine, based on the engagement degree of each account in each of the positive samples and the weight thereof, the ranking score of each of the positive samples in the sample set.

In an embodiment, the determining unit is configured to: for each feedback operation, adjust, in response to a current feedback operation being a low-frequency feedback operation, a weight of the current feedback operation to a ratio of an occurrence frequency of a target high-frequency feedback operation to an occurrence frequency of the low-frequency feedback operation, wherein the occurrence frequency of the target high-frequency feedback operation is an average occurrence frequency of all high-frequency feedback operations in all currently acquired feedback operations; and determine, based on each feedback operation and the adjusted weight thereof, the engagement degree of each account in each of the positive samples.

According to still another aspect of the embodiments of the present disclosure, a server is provided. The server includes:

one or more processors; and

a memory configured to store one or more instructions executable by the one or more processors;

wherein the one or more processors, when loading and executing the one or more instructions, are configured to: receive, from a login account of an application, a recommendation request for display of a multimedia work, wherein the multimedia work is posted by an associated account of the login account in the application; acquire, in response to the recommendation request, a first candidate work set of each type of a plurality of types, wherein the first candidate work set includes multimedia works posted by the associated account; screen the first candidate work sets, and aggregate screening results into a second candidate work set, wherein the second candidate work set includes multimedia works of the plurality of types; and rank multimedia works of the plurality of types in the second candidate work set, and recommend the multimedia works to the login account based on a ranking result.

According to still another aspect of the embodiments of the present disclosure, a storage medium storing one or more instructions is provided. The one or more instructions, when loaded and executed by a processor of a server, cause the server to: receive, from a login account of an application, a recommendation request for display of a multimedia work, wherein the multimedia work is posted by an associated account of the login account in the application; acquire, in response to the recommendation request, a first candidate work set of each type of a plurality of types, wherein the first candidate work set includes multimedia works posted by the associated account; screen the first candidate work sets, and aggregate screening results into a second candidate work set, wherein the second candidate work set includes multimedia works of the plurality of types and rank multimedia works of the plurality of types in the second candidate work set, and recommend the multimedia works to the login account based on a ranking result.

The recommendation request is received from the login account of the application. In response to the recommendation request, the first candidate work sets of the plurality of types posted by the associated account are acquired. Subsequently, the first candidate work sets are screened separately at least based on a server processing parameter, and the screening results are aggregated into the second candidate work set. Finally, the multimedia works in the second candidate work set are ranked and then recommended to a client based on the ranking result. In the embodiments, the ranking process is performed on the works in the second candidate work set which is acquired by aggregating upon the first candidate work sets of the plurality of types being screened, i.e., the works of the plurality of types are ranked in a unified manner, which facilitates improving the accuracy of the ranking result, and thus improving the recommendation accuracy of the multimedia works based on the ranking result.

### BRIEF DESCRIPTION OF THE DRAWINGS

FIG. 1 is a flowchart of a method for recommending works according to an embodiment of the present disclosure;

FIG. 2 is a flowchart of training of a hybrid ranking model according to an embodiment of the present disclosure;

FIG. 3 is a flowchart of determination of a ranking score of each positive sample in a sample set according to an embodiment of the present disclosure;

FIG. 4 is a block diagram of an apparatus for recommending works according to an embodiment of the present disclosure;

FIG. 5 is a block diagram of another apparatus for recommending works according to an embodiment of the present disclosure;

FIG. 6 is a block diagram of yet another apparatus for recommending works according to an embodiment of the present disclosure;

FIG. 7 is a block diagram of a server according to an embodiment of the present disclosure; and

FIG. 8 is a block diagram of a device applicable to a method for recommending works according to an embodiment of the present disclosure,

### DETAILED DESCRIPTION

The terms “first,” “second,” and the like in the description, claims, as well as the above accompanying drawings of the present disclosure are used to distinguish similar objects, but not necessarily used to describe any specific order or precedence order.

Acquiring user information or information related to a user account, such as information about social relationship or identity information, as described in embodiments of the present. disclosure, is authorized by a user or fully authorized by all parties. The method, apparatus, device, or storage medium provided in the present disclosure may acquire, under the premise of being authorized by the user, information of the user.

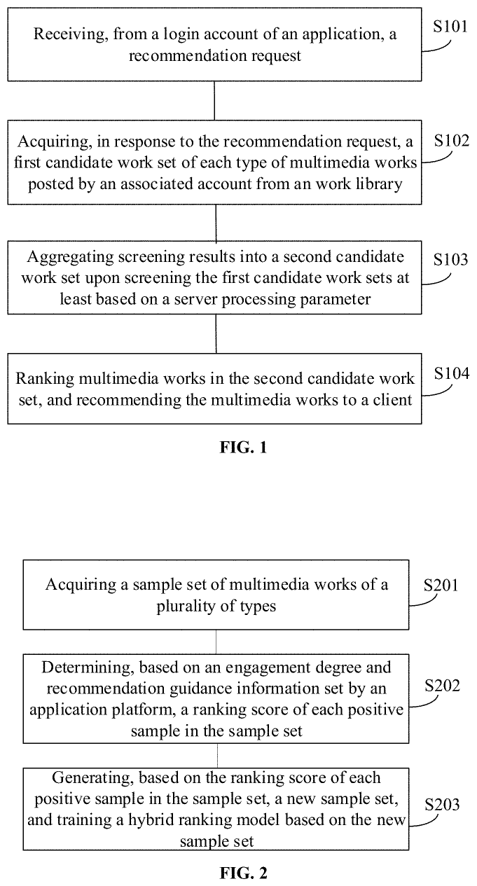

FIG. 1 is a flowchart of a method for recommending works according to an embodiment of the present disclosure. As shown in FIG. 1, the method for recommending works includes the following processes.

In S101, a recommendation request is received from a login account of an application. The recommendation request is used for requesting display of a multimedia work on a target page. The target page is used to display a multimedia work posted by an associated account that establishes a social relationship with the login account in the application.

The multimedia work is posted by the associated account of the login account in the application. A social relationship is established, based on the application, between the login account and the associated account.

The target page may include, but is not limited to, a follow page, and may also include a local page, etc. The multimedia works may include, but are not limited to, works such as live streaming and short videos.

In a case that a user login to the application, the application may send the recommendation request of the login account to a server, wherein the application may include, but is not limited to, an application for posting multimedia works.

In an embodiment of the present disclosure, in the case that the target page is a follow page, the associated account that establishes the social relationship with the login account may include an account followed by the login account; and in the case that the target page is a local page, the associated account that establishes the social relationship with the login account may include an account located in a same city as the login account.

In S102, in response to the recommendation request, a first candidate work set of each type of multimedia works posted by the associated account is acquired from a work library.

S102 is a possible implementation mode of acquiring, in response to the recommendation request, a first candidate work set of each type of a plurality of types. The first candidate work set includes the multimedia work posted by the associated account. Each type refers to each of the plurality of types.

Upon receiving the recommendation request, the server, in response to the recommendation request, may acquire the first candidate work set from the work library. The first. candidate work set of each type may include, but is not limited to, a live-streaming-type first. candidate work set and a short-video-type first candidate work set. The first candidate work set may also be stored at other addresses, for example, the first candidate work set is stored in a local storage of the server, which is not specifically limited in the embodiments of the present disclosure.

In S103, upon the first candidate work sets being screened at least based on a server processing parameter, screening results are aggregated into a second candidate work set.

S103 is a possible implementation mode of screening the first candidate work sets and aggregating the screening results into the second candidate work set. The second candidate work set includes multimedia works of the plurality of types. The screening may be performed based on the server processing parameter or other screening rules, which is not specifically limited in the embodiments of the present disclosure.

In the case that the first candidate work set of each type is acquired, each first candidate work set may be screened based on performance of the server, for example, the server processing parameter, and the screening results may be aggregated into the second candidate work set.

In S104, multimedia works in the second candidate work set are ranked, and the multimedia works are recommended to a client based on a ranking result.

S104 is a process of ranking the multimedia works of the plurality of types in the second candidate work set and recommending the multimedia works to the login account based on the ranking result. During the process, the multimedia works are recommended to the login account, that is, the multimedia works may be sent to a client to which the login account logging on. The recommendation process may include displaying the multimedia works on the client based on the ranking result. For example, the multimedia work with the highest ranking result is displayed first.

In the embodiment of the present disclosure, the multimedia works in the second candidate work set may be ranked based on an engagement degree and recommendation guidance information set by the application platform, i.e., the multimedia works in the second candidate work set are ranked based on a uniform standard, which facilitates improving the accuracy of the ranking result.

The engagement degree is indicative of a positive feedback operation or a negative feedback operation performed by the account on a history multimedia work. The positive feedback operation may include, but is not limited to, a view operation, a like operation, a follow operation, a comment operation, etc., and the negative feedback operation may include, but is not limited to, a report operation, etc.

The recommendation guidance information may include at least one of recommendation information for indicating a recommendation level of the application platform for the history multimedia work and guidance information for prompting the account to perform a positive feedback operation on the history multimedia work. That is, the following three cases are included: the recommendation guidance information may include the recommendation information for indicating the recommendation level of the application platform for the history multimedia work; the recommendation guidance information may include the guidance information for prompting the account to perform a positive, feedback operation on the history multimedia work; and the recommendation guidance information may include the recommendation information for indicating the recommendation level of the application platform for the history multimedia work and the guidance information for prompting the account to perform a positive feedback operation on the history multimedia work.

In the embodiment of the present disclosure, ranking the multimedia works in the second candidate work set based on the engagement degree and the recommendation guidance information set by the application platform includes: acquiring a ranking sequence of the multimedia works of the plurality of types by inputting the multimedia works of the plurality of types in the second candidate work set into a hybrid ranking model. The hybrid ranking model is acquired by training based on the engagement degree and the recommendation guidance information set by the application platform.

The training process may include: training the hybrid ranking model based on the engagement degree and the recommendation guidance information set by the application platform. The hybrid ranking model is used for determining a ranking sequence of the multimedia works based on the engagement degree and the recommendation guidance information. The training process may be accomplished in advance, and the trained hybrid ranking model may be used directly during the ranking process of the second candidate work set. The training process may also be performed at the time of the second candidate work set being needed to be ranked.

According to the embodiment of the present disclosure, the recommendation request is received from the login account of the application. The first candidate work sets of the plurality of types that belong to the multimedia works posted by the associated account are acquired from the work library in response to the recommendation request. Subsequently, the first candidate work sets are screened at least based on a server processing parameter, and the screening results are aggregated into the second candidate work set. Finally, the multimedia works in the second candidate work set are ranked, and the multimedia works are recommended to a client based on the ranking result. In the embodiments, the ranking process is performed on the works in the second candidate work set acquired by aggregating upon the first candidate work sets of the plurality of types being screened, i.e., the works of the plurality of types are ranked in a unified manner, which facilitates improving the accuracy of the ranking result, and thus improving the recommendation accuracy of the multimedia works based on the ranking result.

In order to rank the multimedia works in the second candidate work set using the hybrid ranking model, in the embodiments of the present disclosure, it is necessary to train the hybrid ranking model in advance. As shown in FIG. 2, which is a flowchart of training of the hybrid ranking model according to an embodiment of the present disclosure, the process of training the hybrid ranking model may include the following processes.

In S201, a sample set of multimedia works of a plurality of types is acquired, wherein the sample set includes positive samples and negative samples, the positive sample being a displayed history multimedia work that is tapped by an account, and the negative sample being a displayed history multimedia work s that is not tapped by the account,

S201 is a process of acquiring a plurality of types of sample sets. The sample set includes samples, and each sample may be a multimedia work of any type of the plurality of types. The positive sample is a displayed history multimedia work that is tapped by an account, and the negative sample is a displayed history multimedia work that is not tapped by the account. The display process may be implemented on a target page or other pages, which is not limited in the embodiments of the present disclosure. It should be understood that a work being tapped by an account means that the work is tapped by a user corresponding to the account.

The multimedia works of the plurality of types may include, but are not limited to, works such as live streaming and short videos.

In the embodiment of the present disclosure, a display log includes a user identification (userid) and a work. In response to a work of art account being displayed, the work of the account is a sample; in response to the work being tapped by an account, the work is a positive sample; and in response to the work being not tapped by an account, the work is a negative sample.

In the embodiment of the present disclosure, the display logs of a plurality of types of multimedia works may be acquired. A positive sample is generated and a label is marked as 1 in response to determining, based on a display log, that a displayed corresponding multimedia work is tapped by an account, and a negative sample is generated and a label is marked as 0 in response to determining, based on a display log, that a displayed corresponding multimedia work is not tapped by an account.

In S202, a ranking score of each of the positive samples in the sample set is determined based on the engagement degree and the recommendation guidance information set by the application platform.

The engagement degree of the account may be determined based on a positive feedback operation performed by the account on a history multimedia work and the weight thereof as well as a negative feedback operation performed by the account on the history multimedia work and the weight thereof. The recommendation guidance information set by the application platform may be set by the application platform based on ecological factors or other factors. For example, the ecological factors may include, but are not limited to, traffic inclusive level, etc.

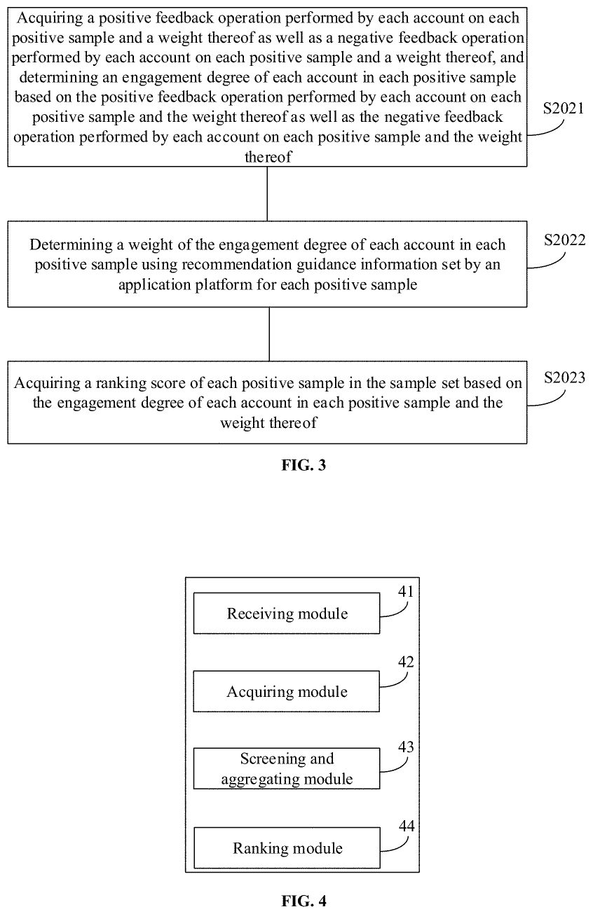

For example, as shown in FIG. 3, determining the ranking score of each positive sample in the sample set may include the following processes.

In S2021, a positive feedback operation performed by each account on each positive sample and a weight thereof as well as a negative feedback operation performed by each account. on each positive sample and a weight thereof are acquired, and the engagement degree of each account in each positive sample is determined based on the positive feedback operation performed by each account on each positive sample and the weight thereof as well as the negative feedback operation performed by each account on each positive sample and the weight thereof

The process of determining the engagement degree in S2021 is a process of determining, based on the acquired positive feedback operation and weight thereof as well as the negative feedback operation and the weight thereof, the engagement degree of each account in each of the positive samples.

The positive feedback operation may include, but is not limited to, a view operation, a like operation, a follow operation, a comment operation, etc., and the negative feedback operation may include, but is not limited to, a report operation, etc.

In the embodiment of the present disclosure, the weight of the positive feedback operation or the weight of the negative feedback operation performed by the account on each positive sample may be determined based on a retention attribution algorithm, and then the engagement degree of each account in each positive sample is acquired by performing a weighting operation based on each feedback operation and a weight thereof.

In some embodiments, a behavior is a feedback operation, which may be a positive feedback operation or a negative feedback operation. For each feedback operation, in response to a current feedback operation being a low-frequency feedback operation, a weight of the current. feedback operation is adjusted to a ratio of an occurrence frequency of a target high-frequency feedback operation to an occurrence frequency of a low-frequency feedback operation. The occurrence frequency of the target high-frequency feedback operation is an average occurrence frequency of all high-frequency feedback operations in all currently acquired feedback operations. The engagement degree of each account in each of the positive samples is determined based on each feedback operation and the adjusted weight thereof.

That is, for each behavior, in response to a current behavior being a low-frequency behavior, a weight of the current behavior is adjusted to a ratio of an occurrence frequency of a target high-frequency behavior to an occurrence frequency of a low-frequency behavior, and an engagement degree of each account in each positive sample is determined based on each behavior and the adjusted weight thereof. The occurrence frequency of the target high-frequency behavior is an average occurrence frequency of all high-frequency behaviors in all currently acquired behaviors.

For example, all the currently acquired behaviors include giving a like and commenting, wherein giving a like is a high-frequency behavior, and commenting is a low-frequency behavior. The pre-counted occurrence frequency of giving a like is 0.1 and the pre-counted occurrence frequency of commenting is 0.001. At this case, the weight of commenting may be adjusted to 100. It should be noted that the behaviors and values involved in this example are merely examples, and may be adjusted as required in practice.

In S2022, a weight of the engagement degree of each account in each positive sample is determined using the recommendation guidance information set by the application platform for each positive sample.

S2022 is a process of determining, based on the recommendation guidance information set by the application platform for each of the positive samples, the weight of the engagement degree of each account in each of the positive samples.

The acceptable levels of the account for different types of multimedia works are different. For example, an acceptable level of the account for short videos is higher than an acceptable level of the account for live streaming. At this time, a weight of an engagement degree of the account in short videos may be increased.

In S2023, the ranking score of each positive sample in the sample set is acquired based on the engagement degree of each account in each positive sample and the weight thereof.

S2023 is a process of determining, based on the engagement degree of each account in each of the positive samples and the weight thereof, the ranking score of each of the positive samples in the sample set.

Upon determining the weight of the engagement degree of each account in each positive sample, the ranking score of each positive sample in the sample set may be acquired based on the engagement degree of each account in each of the positive samples and the weight thereof.

In the embodiment of the present disclosure, the ranking score of each positive sample in the sample set is determined based on the engagement degree and the recommendation guidance information set by the application platform, such that ranking information of different types of multimedia works may be measured based on a uniform standard, which facilitates improving the accuracy of the trained hybrid ranking model.

In addition, the engagement degree and the recommendation level set by the platform may include information in a plurality of dimensions which may well describe features of an application scenario, such that the accuracy of the trained hybrid ranking model may be further improved, i.e., the accuracy of the ranking sequence determined based on the hybrid ranking model may be further improved.

In S203, a new sample set is generated based on the ranking score of each positive sample in the sample set and the sample set, and the hybrid ranking model is trained based on the new sample set.

S203 is a process of training the hybrid ranking model based on the ranking score of each of the positive samples in the sample set and the sample set. In this process, the sample set and generated positive sample may also be directly used instead of generating a new sample set, wherein the generated positive sample may be referred to as a target positive sample. The process of training the hybrid ranking model may include: generating, for each of the positive samples, target positive samples at a quantity equal to the ranking score of each of the positive samples; training, based on the sample set and the target positive sample, a positive-sample probability determining model for determining a probability of the target positive sample; and training the hybrid ranking model based on the probability of the target positive sample and a probability that each sample in the sample set is a positive sample.

In the embodiment of the present disclosure, positive samples at a quantity equal to the ranking score of each of the positive samples may be generated for each positive sample, and a new sample set is acquired based on the sample set and the generated positive sample.

The way of generating positive samples may be directly copying the positive samples.

For example, 5 positive samples may be generated in response to a ranking score of a specific positive sample being 5. For example, 5 positive samples are directly copied, and then a new sample set is formed by the previous sample set and the 5 positive samples.

In the embodiment of the present disclosure, upon acquiring the new sample set, a positive-sample probability determining model may be trained based on the new sample set using a logistic regression algorithm, wherein the positive-sample probability determining model is used to determine a probability of a positive sample in the new sample set. Subsequently, the hybrid ranking model is generated based on the probability of the positive sample in the new sample set and the probability that each sample in the sample set is a positive sample. The probability that each sample in the sample set is a positive sample may be acquired statistically or be acquired based on a pre-trained model.

The process of training the positive-sample probability determination model using the logistic regression algorithm may include:

acquiring the probability of the positive sample by inputting samples in the new sample set into a positive-sample probability determining model, calculating a loss function based on the acquired probability of the positive sample, and updating parameters of the positive-sample probability determining model based on the loss function until the loss function is small enough, wherein a model acquired at this time is the trained positive-sample probability determining model.

In the embodiment of the present disclosure, the positive-sample probability determining model is:

$$\hat{y} = \frac{1}{1 + {e}^{- ( {\sum }_{j} {w}_{j} {x}_{j} + b )}} ,$$

wherein w and b are parameters of the model, j is a feature number in each sample in the new sample set, the sample in the new sample set is a vector, and a feature in the sample refers to each component in the sample.

In the embodiment of the present disclosure, the loss function is:

logloss=Σᵢ(yᵢlogŷₗ+(1−yᵢ)log(1−ŷₗ).

The loss function being small enough means that the model converges, and the model acquired at this time is the trained model.

In the embodiment of the present disclosure, the probability of the positive sample in the new sample set may be calculated via the following Formula 11):

$$Odds = \frac{{\sum }_{{y}_{i} = 1} {S}_{i}}{{\sum }_{{y}_{i} = 0} 1} = \frac{{\sum }_{k} {S}_{i}}{N - k} = \frac{{E}_{S}}{1 - p} ,$$

wherein N and k respectively represent a total number of samples and a number of positive samples, and Sᵢ represents the ranking score of the i^{th} sample.

The following Formula 12) may be acquired based on properties of logistic regression:

$$log Odds = {\sum }_{j} {w}_{j} {x}_{j} + b = log ( \frac{y}{1 - y} ) .$$

The formula

$${E}_{S} = \frac{y}{1 - y} ( 1 - p )$$

may be acquired based on Formula 11) and Formula 12) and in turn, the hybrid ranking model is acquired as:

$${M}_{i} = \frac{\hat{{J}_{ι}} ( 1 - {P}_{i} )}{1 - {\hat{J}}_{ι}} ,$$

wherein Mᵢ represents a ranking score of the i^{th} multimedia work in the different types of multimedia works, Ĵₗ represents a probability that a multimedia work in the different types of multimedia works is tapped, and Pᵢ represents a probability of the i^{th} multimedia work being tapped, wherein Pₗ may be acquired statistically or acquired based on a pre-trained model.

In the embodiment of the present disclosure, the hybrid ranking model for ranking different types of multimedia works is generated based on the logistic regression algorithm, which is easy to implement.

In the embodiment of the present disclosure, the ranking information of each positive sample in the sample set is determined based on the engagement degree and the recommendation guidance information set by the application platform, such that ranking information of different types of multimedia works can be measured based on a uniform measurement standard, which facilitates improving the accuracy of the trained hybrid ranking model. Subsequently, the new sample set is generated based on the ranking information of each positive sample in the sample. set, and the hybrid ranking model is trained based on the new sample set, which are easy to implement.

Referring to FIG. 4, which is a block diagram of an apparatus for recommending works according to an embodiment of the present disclosure, the apparatus includes:

a receiving module 41, configured to receive, from a login account of an application, a recommendation request for display of a multimedia work, wherein the multimedia work is posted by an associated account of the login account in the application;

an acquiring module 42, configured to acquire, in response to the recommendation request received by the receiving module 41, a first candidate work set of each type of a plurality of types, wherein the first candidate work set includes multimedia works posted by the associated account;

a screening and aggregating module 43, configured to screen the first candidate work sets acquired by the acquiring module 42, and aggregate screening results into a second candidate work set, wherein the second candidate work set includes multimedia works of the plurality of types; and

a ranking module 44, configured to rank multimedia works of the plurality of types in the second candidate work set acquired by aggregating by the screening and aggregating module 43, and recommend the multimedia works to the login account based on a ranking result,

The ranking module 44 may be configured to:

rank the multimedia works in the second candidate work set based on an engagement degree and recommendation guidance information set by an application platform, wherein the engagement degree is indicative of a positive feedback operation or a negative feedback operation performed by an account on a history multimedia work, and the recommendation guidance information includes at least one of recommendation information for indicating a recommendation level of the application platform for the history multimedia work and guidance information for prompting the account to perform a positive feedback operation on the history multimedia work.

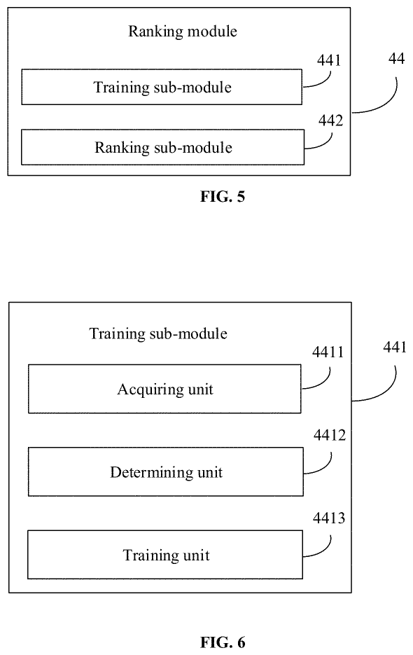

As shown in FIG. 5, which is a block diagram of another apparatus for recommending works according to an embodiment of the present disclosure, based on the embodiment shown in FIG. 4, the ranking module 44 may include:

a training sub-module 441, configured to train a hybrid ranking model based on the engagement degree and the recommendation guidance information set by the application platform, wherein the hybrid ranking model is used to determine a ranking sequence of the multimedia works based on the engagement degree and the recommendation guidance information; and

a ranking sub-module 442, configured to acquire a ranking sequence of the multimedia works in the second candidate work set by inputting the multimedia works in the second work candidate set into the hybrid ranking model trained by the training sub-module 441.

Based on the embodiment shown in FIG. 4, the ranking module 44 may be configured to acquire the ranking sequence of the multimedia works of the plurality of types by inputting the multimedia works of the plurality of types in the second candidate work set into the hybrid ranking model. The hybrid ranking model is acquired by training based on the engagement degree and the recommendation guidance information set by the application platform.

As shown in FIG. 6, which is a block diagram of yet another apparatus for recommending works according to an embodiment of the present disclosure, based on the embodiment shown in FIG. 5, the training sub-module 441 may include:

an acquiring unit 4411, configured to acquire a sample set of multimedia works of the plurality of types, wherein the sample set includes positive samples and negative samples, the positive sample being a displayed history multimedia work that is tapped by an account, and the negative sample being a displayed history multimedia work that is not tapped by the account;

a determining unit 4412, configured to determine, based on the engagement degree and the recommendation guidance information set by the application platform, a ranking score of each positive sample in the sample set acquired by the acquiring unit 4411; and

a training unit 4413, configured to generate a new sample set based on the ranking score of each positive sample in the sample set determined by the determining unit 4412 and the sample set, and train the hybrid ranking model based on the new sample set.

In some embodiments, an apparatus for training a hybrid ranking model for recommending works is further provided. The apparatus may be referred to FIG. 6. The apparatus includes: an acquiring unit, configured to acquire a plurality of types of sample sets, wherein the sample set includes positive samples and negative samples, the positive sample being a displayed history multimedia work that is tapped by an account, and the negative sample being a displayed history multimedia work that is not tapped by the account; a determining unit, configured to determine a ranking score of each of the positive samples in the sample set based on an engagement degree and recommendation guidance information set by an application platform, wherein the engagement degree is indicative of a positive feedback operation or a negative feedback operation performed by an account on a history multimedia work, and the recommendation guidance information includes at least one of recommendation information for indicating a recommendation level of the application platform for the history multimedia work and guidance information for prompting the account to perform a positive feedback operation on the history multimedia work; and a training unit, configured to train a hybrid ranking model based on the ranking score of each of the positive samples in the sample set and the sample set.

In an embodiment, the training unit is configured to: generate, for each of the positive samples, target positive samples at a quantity equal to the ranking score of each of the positive samples; train, based on the sample set and the target positive sample, a positive-sample probability determining model for determining a probability of the target positive sample; and train the hybrid ranking model based on the probability of the target positive sample and a probability that each sample in the sample set is a positive sample.

in an embodiment, the determining unit is configured to: acquire a positive feedback operation performed by each account on each of the positive samples and a weight thereof; acquire a negative feedback operation performed by each account on each of the positive samples and a weight thereof; determine, based on the acquired positive feedback operation and weight thereof as well as the negative feedback operation and the weight thereof, an engagement degree of each account in each of the positive samples; determine, based on the recommendation guidance information set by the application platform for each of the positive samples, a weight of the engagement degree of each account in each of the positive samples; and determine, based on the engagement degree of each account in each of the positive samples and the weight thereof, the ranking score of each of the positive samples in the sample set.

In an embodiment, the determining unit is configured to: for each feedback operation, adjust, in response to a current feedback operation being a low-frequency feedback operation, a weight of the current feedback operation to a ratio of an occurrence frequency of a target high-frequency feedback operation to an occurrence frequency of the low-frequency feedback operation, wherein the occurrence frequency of the target high-frequency feedback operation is an average occurrence frequency of all high-frequency feedback operations in all currently acquired feedback operations; and determine, based on each feedback operation and the adjusted weight thereof, an engagement degree of each account in each of the positive samples.

With regard to the apparatus in the above embodiments, the specific manner in which the various modules perform operations is described in detail in the embodiments of the method, which is not described in detail herein.

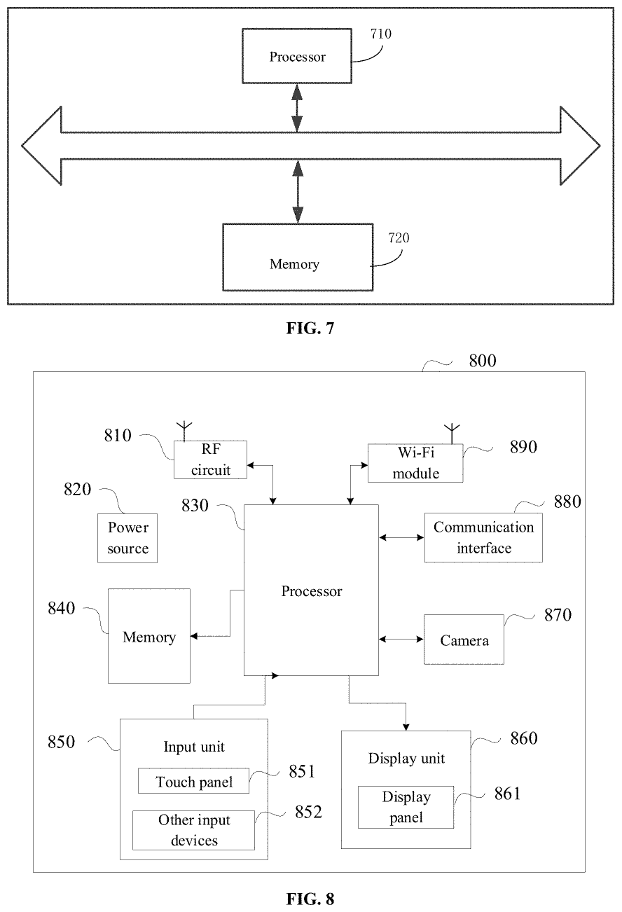

FIG. 7 is a block diagram of a server according to an embodiment of the present disclosure. As shown in FIG. 7, the server includes one or more processors 710 and a memory 720 configured for storing one or more instructions executable by the one or more processors 710, wherein the one or more processors, when loading and executing the one or more instructions, are caused to perform the method for recommending works. In addition to the processor 710 and the memory 720 shown in FIG. 7, the server may usually include other hardware depending on the actual function of work recommendation, which is not repeated herein.

In an embodiment, a storage medium including one or more instructions, such as the memory 720 including the one or more instructions, is further provided. The one or more instructions, when loaded and executed by the one or more processors 710, cause the one or more processors to perform the method for recommending works. In some embodiments, the storage medium may be a non-transitory computer-readable storage medium. For example, the non-transitory computer-readable storage medium may be a read-only memory (ROM), a random-access memory (RAM), a compact disc read-only memory (CD-ROM), a magnetic tape, a floppy disc, an optical data storage device, or the like.

In an embodiment, a computer program product is further provided, An electronic device, when running the computer program product, is caused to perform the method for recommending works.

FIG. 8 is a block diagram of a device applicable to the method for recommending works according to an embodiment of the present disclosure. As shown in FIG. 8, the embodiment of the present disclosure provides a device 800 applicable to the method for recommending works. The device 800 includes a radio frequency (RF) circuit 810, a power source 820, a processor 830, a memory 840, an input unit 850, a display unit 860, a camera 870, a communication interface 880, a wireless fidelity (Wi-Fi) module 890, and the like. It can be understood by those skilled in the art that the structure of the device shown in FIG. 8 does not constitute a limitation to the device, and the device provided by the embodiments of the present disclosure may include more or fewer components than those illustrated, combine some components, or adopt different component arrangements.

The following describes the components of the device 800 in detail with reference to FIG. 8.

The RF circuit 810 may be configured to receive and transmit data during communication or calls. In particular, upon receiving downlink data from a base station, the RF circuit 810 sends the received downlink data to the processor 830 for processing, and additionally, sends uplink data to be sent to the base station. Usually, the RF circuit 810 includes, but is not limited to, an antenna, at least one amplifier, a transceiver, a coupler, a low noise amplifier (LNA), a duplexer, and the like.

In addition, the RF circuit 810 may also communicate with the network and other devices via wireless communication. The above wireless communication may be implemented based on any communication standard or protocol, including but not limited to a global system of mobile communication (GSM), a general packet radio service (GPRS), code division multiple access (CDMA), wideband code division multiple access (WCDMA), long term evolution (LTE), e-mail, a short messaging service (SMS), and the like.

The Wi-Fi technology is a short-range wireless transmission technology, and the device 800 may be connected to an access point (AP) through the Wi-Fi module 890, so as to access the data network. The Wi-Fi module 890 may be configured to receive and transmit data during communication.

The device 800 may be physically connected to other devices through the communication interface 880. In some embodiments, the communication interface 880 is connected to communication interfaces of other devices via cables to enable data transmission between the device 800 and other devices.

In the embodiment of the present disclosure, the device 800 may implement communication and send information to other contacts, such that the device 800 requires a data transmission function, i.e., the device 800 needs to include a communication module inside. Although FIG. 8 shows the communication modules such as the RF circuit 810, the Wi-Fi module 890, and the communication interface 880, it can be understood that the device 800 includes at least one of the above components or includes other communication modules for communication (for example, a Bluetooth module), so as to transmit data.

For example, in the case that the device 800 is a cell phone, the device 800 may include. the RF circuit 810 and may also include the Wi-Fi module 890; in the case that the device 800 is a computer, the device 800 may include the communication interface 880 and may also include the Wi-Fi module 890; and in the case that the device 800 is a tablet computer, the device 800 may include the Wi-Fi module.

The memory 840 may be configured to store a software program and a module. The processor 830, when running the software program and module stored in the memory 840, executes the function applications and data processing of the device 800, and the processor 830, upon executing one or more program codes in the memory 840, may perform some or all of the processes in FIGS. 1 and 2 of the embodiments of the present disclosure.

In some embodiments, the memory 840 may mainly include a program storage area and a data storage area. The program storage area may store an operating system, various applications (for example, a communication application), a face recognition module, and the like, and the data storage area may store data created during the usage of the device (e.g., various multimedia files such as pictures or video files, a face information template, or the like).

In addition, the memory 840 may include a high-speed random-access memory and may further include a non-volatile memory, such as at least one of a magnetic disk storage, a flash memory, or other volatile solid-state memory.

The input unit 850 may be configured to receive numeric or character information input by an account and generate a key signal input related to account settings and function controls of the device 800.

In some embodiments, the input unit 850 may include a touch panel 851 and other input devices 852.

The touch panel 851, also referred to as a touch screen, may detect touch operations of the account on or near the touch panel (for example, operations that the account performs on the touch panel 851 or near the touch panel 851 using any proper article or accessory such as a finger, a stylus, or the like), and drive a corresponding connecting apparatus based on a predetermined program. In sonic embodiments, the touch panel 851 may include two parts: a touch detection device and a touch controller. The touch detection device detects the touch orientation of the account, detects a signal generated due to the touch operation, and transmits the signal to the touch controller. The touch controller receives the touch information from the touch detection device, converts the touch information into contact coordinates, sends the contact coordinates to the processor 830, and may receive and execute commands from the processor 830. In addition, the touch panel 851 may have various types such as resistive, capacitive, infrared, and surface acoustic waves.

In sonic embodiments, other input devices 852 may include, but are not limited to, one or more of a physical keyboard, a function key (such as a volume control button and a switch button), a trackball, a mouse, a joystick, and the like.

The display unit 860 may be configured to display information input by or provided to the account and various menus of the device 800. The display unit 860 is a display system of the device 800 and is configured to present an interface and achieve human-computer interaction.

The display unit 860 may include a display panel 861. In some embodiments, the display panel 861 may be implemented in the form of a liquid crystal display (LCD), an organic light-emitting diode (OLED), or the like.

Further, the touch panel 851 may cover the display panel 861. Upon detecting a touch operation on or near the touch panel, the touch panel 851 transmits the touch operation to the processor 830 for determining the type of the touch event. Subsequently, the processor 830, based on the type of the touch event, provides a corresponding visual output on the display panel 861.

Although in FIG. 8, the touch panel 851 and the display panel 861 are shown as two independent components to achieve the input and output functions of the device 800, in some embodiments, the touch panel 851 and the display panel 861 may be integrated to achieve the input and output functions of the device 800.

The processor 830 is a control center of the device 800 that connects various components via various interfaces and lines, and the processor 830, when running or executing the software programs and/or modules stored in the memory 840 and invoking data stored in the memory 840, executes various functions of the device 800 and processes data, so as to implement various services based on the device.

In some embodiments, the processor 830 may include one or more processing units. In some embodiments, the processor 830 may integrate an application processor and a modem processor, wherein the application processor mainly processes an operating system, an account interface, an application, and the like; and the modem processor mainly processes wireless communications. It can be understood that the above-described modern processor may also not be integrated into the processor 830.

The camera 870 is configured to implement a shooting function of the device 800, such as taking pictures or videos. The camera 870 may further be configured to implement a scanning function of the device 800, such as scanning a scanning object (such as a QR code or a bar code).

The device 800 may further include the power source 820 (for example, a battery) for powering up the various components. In some embodiments, the power source 820 may be logically connected to the processor 830 via a power management system, so as to manage charging, discharging, power consumption, etc. via the power management system.

In an embodiment, the device 800 may be implemented by one or more of an application specific integrated circuit (ASIC), a digital signal processor (DSP), a digital signal processing device (DSPD), a programmable logic device (PLD), a field programmable gate array (FPGA), controller, a micro-controller, a micro-processor, and other electronic components, for performing the following operations: receiving, from a login account of an application, a recommendation request for display of a multimedia work, wherein the multimedia work is posted by an associated account of the login account in the application; acquiring, in response to the recommendation request, a first candidate work set of each type of a plurality of types, wherein the first candidate work set includes multimedia works posted by the associated account; screening the first candidate work sets, and aggregating screening results into a second candidate work set, wherein the second candidate work set includes multimedia works of the plurality of types; and ranking multimedia works of the plurality of types in the second candidate work set, and recommending the multimedia works to the login account based on a ranking result.

In some embodiments, the processor, when executing the one or more instructions, is further configured to: rank the multimedia works in the second candidate work set based on an engagement degree and recommendation guidance information set by an application platform. The engagement degree is indicative of a positive feedback operation or a negative feedback operation performed by an account on a history multimedia work. The recommendation guidance information includes at least one of recommendation information for indicating a recommendation level of the application platform for the history multimedia work and guidance information for prompting an account to perform a positive feedback operation on the history multimedia work.

In some embodiments, the processor, when executing the one or more instructions, is further configured to: acquire a ranking sequence of the multimedia works of the plurality of types by inputting the multimedia works of the plurality of types in the second candidate work set into a hybrid ranking model. The hybrid ranking model is acquired by training based on the engagement degree and the recommendation guidance information set by the application platform,

In some embodiments, the training process of the hybrid ranking model includes: acquiring a plurality of types of sample sets, wherein the sample set includes positive samples and negative samples, the positive sample being a displayed history multimedia work that is tapped by an account, and the negative sample being a displayed history multimedia work that is not tapped by the account; determining a ranking score of each of the positive samples in the sample set based on an engagement degree and recommendation guidance information set by an application platform; and training the hybrid ranking model based on the ranking score of each of the positive samples in the sample set and the sample set.

In some embodiments, generating a new sample set based on ranking information of each of the positive samples in the sample set and the sample set, and training the hybrid ranking model based on the new sample set include: generating, for each of the positive samples, target positive samples at a quantity equal to the ranking score of each of the positive samples; training, based on the sample set and the target positive sample, a positive-sample probability determining model for determining a probability of the target positive sample; and training the hybrid ranking model based on the probability of the target positive sample and a probability that each sample in the sample set is a positive sample.

In some embodiments, determining the ranking score of each of the positive samples in the sample set based on the engagement degree and the recommendation guidance information set by the application platform includes: acquiring a positive feedback operation performed by each account on each of the positive samples and a weight thereof; acquiring a negative feedback operation performed by each account on each of the positive samples and a weight thereof; determining, based on the acquired positive feedback operation and weight thereof as well as the negative feedback operation and the weight thereof, an engagement degree of each account in each of the positive samples; determining, based on the recommendation guidance information set by the application platform for each of the positive samples, a weight of the engagement degree of each account in each of the positive samples; and determining, based on the engagement degree of each account in each of the positive samples and the weight thereof, the ranking score of each of the positive samples in the sample set.

In some embodiments, determining, based on the acquired positive feedback operation and weight thereof as well as the negative feedback operation and the weight thereof, the engagement degree of each account in each of the positive samples includes: for each feedback operation, adjusting, in response to a current feedback operation being a low-frequency feedback operation, a weight of the current feedback operation to a ratio of an occurrence frequency of a target high-frequency feedback operation to an occurrence frequency of the low-frequency feedback operation, wherein the occurrence frequency of the target high-frequency feedback operation is an average occurrence frequency of all high-frequency feedback operations in all currently acquired feedback operations; and determining, based on each feedback operation and the adjusted weight thereof, an engagement degree of each account in each of the positive samples.

The above device 800 may be a server or other devices, for example, a terminal device. In some embodiments, a server is taken as an example of the device 800 for explanation. The server may include a work recommending module and a training module of a hybrid ranking model for recommending works, which are capable of calling each other and feeding back to each other. For example, the training module of the hybrid ranking model for recommending works may train the hybrid ranking model based on a sample, and the work recommending module, upon receiving a recommendation request, may call, in response to the recommendation request, the hybrid ranking model trained by the training module of the hybrid ranking model for recommending works, and acquire a ranking result by ranking the multimedia works in the second work candidate set based on the hybrid ranking model. In another example, the work recommending module may receive the recommendation request, and rank and recommend some multimedia works in response to the recommendation request. The training module of the hybrid ranking model for recommending works may call the work recommending module, extract history processing data of the work recommending module, and train the hybrid ranking model using the history processing data as a sample, or optimize, based on the history processing data, the trained hybrid ranking model, and provide the optimized hybrid ranking model for the work recommending module to call, so as to rank the multimedia works.

What is claimed is:

1. A method for recommending works, comprising:
receiving, from a login account of an application, a recommendation request for display of a multimedia work, wherein the multimedia work is posted by an associated account of the login account in the application;
acquiring, in response to the recommendation request, a first candidate work set of each type of a plurality of types, wherein the first candidate work set comprises multimedia works posted by the associated account;
screening the first candidate work set of each type, and aggregating screening results into a second candidate work set, wherein the second candidate work set comprises multimedia works of the plurality of types; and
ranking multimedia works of the plurality of types in the second candidate work set, and recommending the multimedia works to the login account based on a ranking result.

2. The method according to claim 1, wherein ranking the multimedia works of the plurality of types in the second candidate work set comprises:
ranking the multimedia works in the second candidate work set based on an engagement degree and recommendation guidance information set by an application platform, wherein the engagement degree is indicative of a positive feedback operation or a negative feedback operation performed by an account on a history multimedia work, and the recommendation guidance information comprises at least one of recommendation information for indicating a recommendation level of the application platform for the history multimedia work and guidance information for prompting the account to perform a positive feedback operation on the history multimedia work.

3. The method according to claim 2, wherein said ranking the multimedia works in the second candidate work set based on the engagement degree and the recommendation guidance information set by the application platform comprises:
acquiring a ranking sequence of the multimedia works of the plurality of types by inputting the multimedia works of the plurality of types in the second candidate work set into a hybrid ranking model, wherein the hybrid ranking model is acquired by training based on the engagement degree and the recommendation guidance information set by the application platform.

4. The method according to claim 3, further comprising:
training, based on the engagement degree and the recommendation guidance information set by the application platform, the hybrid ranking model, wherein the hybrid ranking model is used for determining, based on the engagement degree and the recommendation guidance information, the ranking sequence of the multimedia works; and
acquiring the ranking sequence of the multimedia works of the plurality of types by inputting the multimedia works of the plurality of types in the second candidate work set into the hybrid ranking model comprises:
acquiring the ranking sequence of the multimedia works of the plurality of types in the second candidate work set by inputting the multimedia works of the plurality of types in the second candidate work set into the trained hybrid ranking model.

5. The method according to claim 4, wherein said training, based on the engagement degree and the recommendation guidance information set by the application platform, the hybrid ranking model comprises:
acquiring a plurality of types of sample sets, wherein the sample sets comprise positive samples and negative samples, a positive sample being a displayed history multimedia work that is tapped by an account, and a negative sample being a displayed history multimedia work that is not tapped by the account;
determining a ranking score of each of the positive samples in the sample sets based on the engagement degree and the recommendation guidance information set by the application platform, wherein the engagement degree is indicative of the positive feedback operation or the negative feedback operation performed by the account on the history multimedia work, and the recommendation guidance information comprises at least one of the recommendation information for indicating the recommendation level of the application platform for the history multimedia work and the guidance information for prompting the account to perform a positive feedback operation on the history multimedia work; and
training the hybrid ranking model based on the ranking score of each of the positive samples in each sample set.

6. The method according to claim 5, wherein said training the hybrid ranking model based on the ranking score of each of the positive samples in each sample set comprises:
generating, for each of the positive samples, a target positive sample at a quantity equal to the ranking score of each of the positive samples;
training, based on the sample set and the target positive sample, a positive-sample probability determining model for determining a probability of the target positive sample; and
training the hybrid ranking model based on the probability of the target positive sample and a probability that each sample in the sample set is a positive sample.

7. The method according to claim 5, wherein determining the ranking score of each of the positive samples in the sample sets based on the engagement degree and the recommendation guidance information set by the application platform comprises:
acquiring a positive feedback operation performed by each account on each of the positive samples and a weight thereof;
acquiring a negative feedback operation performed by each account on each of the positive samples and a weight thereof;
determining, based on the acquired positive feedback operation and weight thereof as well as the negative feedback operation and the weight thereof, the engagement degree of each account in each of the positive samples;
determining, based on the recommendation guidance information set by the application platform for each of the positive samples, a weight of the engagement degree of each account in each of the positive samples; and
determining, based on the engagement degree of each account in each of the positive samples and the weight thereof, the ranking score of each of the positive samples in the sample set.

8. The method according to claim 7, wherein determining, based on the acquired positive feedback operation and weight thereof as well as the negative feedback operation and the weight thereof, the engagement degree of each account in each of the positive samples comprises:
for each feedback operation, adjusting, in response to a current feedback operation being a low-frequency feedback operation, a weight of the current feedback operation to a ratio of an occurrence frequency of a target high-frequency feedback operation to an occurrence frequency of the low-frequency feedback operation, wherein the occurrence frequency of the target high-frequency feedback operation is an average occurrence frequency of all high-frequency feedback operations in all currently acquired feedback operations; and
determining, based on each feedback operation and the adjusted weight thereof, the engagement degree of each account in each of the positive samples.

9. A method for training a hybrid ranking model for recommending works, comprising:
acquiring a plurality of types of sample sets, wherein the sample sets comprise positive samples and negative samples, a positive sample being a displayed history multimedia work that is tapped by an account, and a negative sample being a displayed history multimedia work that is not tapped by the account;
determining a ranking score of each of the positive samples in the sample sets based on an engagement degree and recommendation guidance information set by an application platform, wherein the engagement degree is indicative of a positive feedback operation or a negative feedback operation performed by the account on a history multimedia work, and the recommendation guidance information comprises at least one of recommendation information for indicating a recommendation level of the application platform for the history multimedia work and guidance information for prompting the account to perform a positive feedback operation on the history multimedia work; and
training the hybrid ranking model based on the ranking score of each of the positive samples in each sample set.

10. The method according to claim 9, wherein training the hybrid ranking model based on the ranking score of each of the positive samples in each sample set comprises:
generating, for each of the positive samples, target positive samples at a quantity equal to the ranking score of each of the positive samples;
training, based on the sample set and the target positive sample, a positive-sample probability determining model for determining a probability of the target positive sample; and
training the hybrid ranking model based on the probability of the target positive sample and a probability that each sample in the sample set is a positive sample.

11. The method according to claim 9, wherein determining the ranking score of each of the positive samples in the sample sets based on the engagement degree and the recommendation guidance information set by the application platform comprises:
acquiring a positive feedback operation performed by each account on each of the positive samples and a weight thereof;
acquiring a negative feedback operation performed by each account on each of the positive samples and a weight thereof;
determining, based on the acquired positive feedback operation and weight thereof as well as the negative feedback operation and the weight thereof, the engagement degree of each account in each of the positive samples;
determining, based on the recommendation guidance information set by the application platform for each of the positive samples, a weight of the engagement degree of each account in each of the positive samples; and
determining, based on the engagement degree of each account in each of the positive samples and the weight thereof, the ranking score of each of the positive samples in each sample set.

12. The method according to claim 11, determining, based on the acquired positive feedback operation and the weight thereof as well as the negative feedback operation and the weight thereof, the engagement degree of each account in each of the positive samples comprises:
for each feedback operation, adjusting, in response to a current feedback operation being a low-frequency feedback operation, a weight of the current feedback operation to a ratio of an occurrence frequency of a target high-frequency feedback operation to an occurrence frequency of the low-frequency feedback operation, wherein the occurrence frequency of the target high-frequency feedback operation is an average occurrence frequency of all high-frequency feedback operations in all currently acquired feedback operations; and
determining, based on each feedback operation and the adjusted weight thereof, the engagement degree of each account in each of the positive samples.

13. A server for recommending works, comprising:
one or more processors; and
a memory configured to store one or more instructions executable by the one or more processors;
wherein the one or more processors, upon loading and executing the one or more instructions, are configured to:
receive, from a login account of an application, a recommendation request for display of a multimedia work, wherein the multimedia work is posted by an associated account of the login account in the application;
acquire, in response to the recommendation request, a first candidate work set of each type of a plurality of types, wherein the first candidate work set comprises multimedia works posted by the associated account;
screen the first candidate work set of each type, and aggregate screening results into a second candidate work set, wherein the second candidate work set comprises multimedia works of the plurality of types; and
rank multimedia works of the plurality of types in the second candidate work set, and recommend the multimedia works to the login account based on a ranking result.

14. The server according to claim 13, wherein the one or more processors, upon loading and executing the one or more instructions, are configured to:
rank the multimedia works in the second candidate work set based on an engagement degree and recommendation guidance information set by an application platform, wherein the engagement degree is indicative of a positive feedback operation or a negative feedback operation performed by an account on a history multimedia work, and the recommendation guidance information comprises at least one of recommendation information for indicating a recommendation level of the application platform for the history multimedia work and guidance information for prompting the account to perform a positive feedback operation on the history multimedia work.

15. The server according to claim 14, wherein the one or more processors, upon loading and executing the one or more instructions, are configured to:
acquire a ranking sequence of the multimedia works of the plurality of types by inputting the multimedia works of the plurality of types in the second candidate work set into a hybrid ranking model, wherein the hybrid ranking model is acquired by training based on the engagement degree and the recommendation guidance information set by the application platform.

16. The server according to claim 15, wherein the one or more processors, upon loading and executing the one or more instructions, are configured to:
train, based on the engagement degree and the recommendation guidance information set by the application platform, the hybrid ranking model, wherein the hybrid ranking model is used for determining, based on the engagement degree and the recommendation guidance information, the ranking sequence of the multimedia works; and
acquire the ranking sequence of the multimedia works of the plurality of types in the second candidate work set by inputting the multimedia works of the plurality of types in the second candidate work set into the trained hybrid ranking model.

17. The server according to claim 16, wherein the one or more processors, upon loading and executing the one or more instructions, are configured to:
acquire a plurality of types of sample sets, wherein the sample sets comprise positive samples and negative samples, a positive sample being a displayed history multimedia work that is tapped by an account, and a negative sample being a displayed history multimedia work that is not tapped by the account;
determine a ranking score of each of the positive samples in the sample sets based on the engagement degree and the recommendation guidance information set by the application platform, wherein the engagement degree is indicative of the positive feedback operation or the negative feedback operation performed by the account on the history multimedia work, and the recommendation guidance information comprises at least one of the recommendation information for indicating the recommendation level of the application platform for the history multimedia work and the guidance information for prompting the account to perform a positive feedback operation on the history multimedia work; and
train the hybrid ranking model based on the ranking score of each of the positive samples in each sample set.

18. The server according to claim 17, wherein the one or more processors, upon loading and executing the one or more instructions, are configured to:
generate, for each of the positive samples, target positive samples at a quantity equal to the ranking score of each of the positive samples;
train, based on the target positive sample and a corresponding sample set, a positive-sample probability determining model for determining a probability of the target positive sample; and
train the hybrid ranking model based on the probability of the target positive sample and a probability that each sample in the corresponding sample set is a positive sample.

19. The server according to claim 17, wherein the one or more processors, upon loading and executing the one or more instructions, are configured to:
acquire a positive feedback operation performed by each account on each of the positive samples and a weight thereof;
acquire a negative feedback operation performed by each account on each of the positive samples and a weight thereof;
determine, based on the acquired positive feedback operation and weight thereof as well as the negative feedback operation and the weight thereof, the engagement degree of each account in each of the positive samples;
determine, based on the recommendation guidance information set by the application platform for each of the positive samples, a weight of the engagement degree of each account in each of the positive samples; and
determine, based on the engagement degree of each account in each of the positive samples and the weight thereof, the ranking score of each of the positive samples in each sample sets.

20. The server according to claim 19, wherein the one or more processors, upon loading and executing the one or more instructions, are configured to:
for each feedback operation, adjust, in response to a current feedback operation being a low-frequency feedback operation, a weight of the current feedback operation to a ratio of an occurrence frequency of a target high-frequency feedback operation to an occurrence frequency of the low-frequency feedback operation, wherein the occurrence frequency of the target high-frequency feedback operation is an average occurrence frequency of all high-frequency feedback operations in all currently acquired feedback operations; and
determine, based on each feedback operation and the adjusted weight thereof, the engagement degree of each account in each of the positive samples.
